(19) United States
(12) Patent Application Publication
(10) Pub. No.: US 2020/0172775 A1
(43) Pub. Date: Jun. 4, 2020

(54) ULTRA RAPID CURING STRUCTURAL ADHESIVE

(71) Applicant: ILLINOIS TOOL WORKS INC., Glenview, IL (US)

(72) Inventors: Ranjith Kokkot, Glenview, IL (US); Parvathy Mohan Chandramohanan, Glenview, IL (US); Subodh Deshpande, Glenview, IL (US)

(73) Assignee: Illinois Tool Works Inc., Glenview, IL (US)

(21) Appl. No.: 16/623,994

(22) PCT Filed: Jun. 18, 2018
(86) PCT No.: PCT/US2018/038022

§ 371 Date: Dec. 18, 2019

Related U.S. Application Data
(60) Provisional application No. 62/521,794, filed on Jun. 19, 2017.

(51) Int. Cl. C09J 163/04; C09J 5/06; C08G 59/38; B32B 5/02; B32B 5/26; B32B 7/12; B29C 65/48; B29C 65/00

(52) U.S. Cl. CPC C09J 163/04; B29L 2031/3055; C08G 59/38; B32B 5/02; B32B 5/26; B32B 7/12; B29C 65/4835; B29C 66/7212; B29C 66/7392; C09J 2463/00; C09J 2477/006; C09J 2205/31; C09J 2409/00; B32B 2262/0276; B32B 2262/106; B32B 2260/021; B32B 2260/046; C09J 5/06

(57) ABSTRACT

A process for adhesively bonding at least two substrates includes the application to the at least two substrates of an uncured adhesive formulation. The uncured adhesive formulation includes at least two curable resin components of epoxy novolac resin, bisphenol A-epichlorohydrin epoxy, or 4,4′-Isopropylidenediphenol, oligomeric reaction products with 1-chloro-2,3-epoxypropane in a total amount of at least 60 total weight percent. An epoxy curing agent is also present in the formulation. The uncured adhesive formulation cures at an elevated onset temperature of at least 140° C. to adhesively bonding the at least two substrates. The adhesive formulation is also provided with a cure accelerator. An assembly is provided that includes a first substrate of nylon or carbon fiber filled polymer and a second substrate of nylon or carbon fiber filled polymer. A layer of the cured adhesive formulation is present in simultaneous contact with the first substrate and the second substrate.

### RELATED APPLICATIONS

This application claims priority benefit of U.S. Provisional Application Ser. No. 62/521,794 filed 19 Jun. 2017; the contents of which are hereby incorporated by record.

### FIELD OF THE INVENTION

The present invention in general relates to adhesives and in particular to ultra-rapid curing adhesives for joining composites in form bonded assemblies from at least two substrates.

### BACKGROUND OF THE INVENTION

Weight savings in the automotive, transportation, and logistics based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

Composite materials are engineered or naturally occurring materials made from two or more constituent materials with significantly different physical or chemical properties which remain separate and distinct at the macroscopic or microscopic scale within the finished structure. There are two categories of constituent materials: matrix and reinforcement. At least one portion of each type is required. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

Commercially produced composites often use a polymer matrix material often called a resin solution. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

The use of fiber inclusions and commonly ground minerals to strengthen a matrix is well known to the art. Well established mechanisms for the strengthening include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM); hereafter referred to collectively as “molding compositions”, fiber strengthening has traditionally involved usage of chopped glass fibers. There is a growing appreciation in the field of molding compositions that replacing in part, or all of the glass fiber in molding compositions with carbon fiber can provide improved component properties.

The use of carbon fibers in composites, sheet molding compositions, and resin transfer molding (RTM) results in formed components with a lower weight as compared to glass fiber reinforced materials. The weight savings achieved with carbon fiber reinforcement stems from the fact that carbon has a lower density than glass and produces stronger and stiffer parts at a given thickness.

Fiber-reinforced composite materials can be divided into two main categories normally referred to as short fiber-reinforced materials and continuous fiber-reinforced materials. Continuous reinforced materials often constitute a layered or laminated structure. The woven and continuous fiber styles are typically available in a variety of forms, being pre-impregnated with the given matrix (resin), dry, uni-directional tapes of various widths, plain weave, harness satins, braided, and stitched. Various methods have been developed to reduce the resin content of the composite material, by increasing the fiber content. Typically, composite materials may have a ratio that ranges from 60% resin and 40% fiber to a composite with 40% resin and 60% fiber content. The strength of a product formed with composites is greatly dependent on the ratio of resin to reinforcement material.

High quality surface finishes in the auto industry are characterized by a high surface sheen, and are generally obtained only with highly tailored resin formulations that contain glass fibers. Surfaces without visible distortions are generally required for vehicle surface panels: doors, hoods, quarter panels, trunks, roof structures, bumpers, etc., which make up a significant amount of weight in a vehicle.

As thermoset, thermoplastics, and carbon fiber Reinforced Plastics (CFRP) are increasingly being used to make vehicle body panels, in order to achieve both weight reduction and the high surface sheen many such parts are formed with two components: an inner portion that is carbon fiber rich and imparts high strength and weight reduction, laminated to an outer portion that is glass fiber rich and contributes the attribute of high surface sheen. In order to join these composite portions together adhesives instead of traditional spot welding are used. Adhesives that are used have considerable requirements as to strength and flexibility over a range of temperatures and temperature cycles during vehicle manufacture and during the lifetime of a vehicle. Furthermore, mechanical and thermal properties (e.g., coefficients of thermal expansion (CTE)) of bonded assemblies must be accounted for, using adhesives with low shrinkage that maintain constant joint thickness of applied adhesive while controlling cure temperatures to avoid thermal damage to composite surfaces, and providing constant cure conditions across an assembly to be bonded.

Existing adhesives are liquid in state and are stored under controlled temperatures, leading to inherent handling, transportation, and application difficulties. Existing adhesives are slow curing with inadequate green strength with ultimate strength only after 1 hour or more, which leads to slow cycle times in manufacturing. The existing adhesives require surface preparation on substrates that may not be economically viable and practically feasible in assembly lines due to increased cycle time. Existing adhesives adhere only to metallic fasteners, whereas plastic fasteners are increasingly being used in composite manufacturing with CFRP and Nylon. Ultra violet (UV) curable adhesives require transparency of the substrates to be bonded for effective curing which is not practical in automotive parts.

Thus, there exists a need for rapid curing adhesives for joining composite materials in bonded assemblies.

### SUMMARY OF THE INVENTION

A process for adhesively bonding at least two substrates includes the application to the at least two substrates of an uncured adhesive formulation. The uncured adhesive formulation includes at least two curable resin components of epoxy novolac resin, bisphenol A-epichlorohydrin epoxy, or 4,4′-isopropylidenediphenol, oligomeric reaction products with 1-chloro-2,3-epoxypropane in a total amount of at least 60 total weight percent. An epoxy curing agent is also present e formulation. The uncured adhesive formulation is allowed to cure at an elevated onset temperature of at least 140° C. to adhesively bonding the at least two substrates.

The adhesive formulation is also provided with a cure accelerator. An assembly is provided that includes a first substrate of nylon or carbon fiber filled polymer and a second substrate of nylon or carbon fiber filled polymer. A layer of the cured adhesive formulation is present in simultaneous contact with the first substrate and the second substrate.

### BRIEF DESCRIPTION OF THE DRAWING

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an isothermal (180° C.) DSC thermogram graph that depicts the rapid curing behavior of an inventive adhesive inclusive of an accelerator;

FIG. 2 is a DSC thermogram graph that depicts cure rates at various isothermal temperatures without accelerator; and

FIG. 3 is a DSC thermogram graph that depicts cure rates at 160° C. and 180° C. isothermal conditions in the presence of accelerator.

### DESCRIPTION OF THE INVENTION

The present invention has utility as a rapid-cure one component epoxy adhesive for use in bonding thermoplastic/thermoset composites and for bonding plastic fasteners to composites illustratively including carbon fiber reinforced polymers (CFRP). Embodiments of the very high strength high temperature rapid curing structural adhesive system may be pre-applied on automotive fasteners to bond CFRP without any surface preparation. Embodiments of the rapid curing adhesive provide high mechanical performance, with the ability to withstand low and high temperature cycles during manufacturing processing and under final application working conditions.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Embodiments of the inventive rapid curing adhesive are solid or semisolid at room temperature when in an uncured state and cure at an elevated temperature and retain uncured tack free properties up to 60° C., which enables hassle free handling and transportation of the adhesive.

As used herein, a semisolid is defined as a substance having a viscosity under standard temperature and pressure (STP) of greater than 74,000 centiPoise (cP) and with values above 1,000,000 cP approaching solids. Surface preparations on substrates are not required prior to the application of the inventive adhesive. When cured at elevated temperatures embodiments of the adhesive obtain an extraordinary short term holding strength of greater than 2 MPa adhesive lap shear strength after only a 15 second exposure at 180° C. that reduces manufacturing cycle times. Embodiments of the rapid curing adhesive have outstanding thermal and mechanical properties even at −40° C., and have a shelf life of greater than 6 months at ambient temperatures with no need of controlled storage temperatures.

Embodiments of the rapid curing adhesive display excellent adhesion properties on carbon reinforced polymers (CFRP) and filled nylon substrates. In a specific inventive embodiment, the adhesive may be pre-applied on nylon or plastic fasteners at 90° C. and stored prior to use on an assembly line for bonding composite substrates. The tack free properties of up to 60° C. for the adhesive takes into account the various temperature zones found on the assembly line before bonding to avoid fusing the pre-applied fasteners during transportation and handling. Fasteners may be mounted on substrates within 15 seconds at 180° C. and exhibit adequate short term holding strength/green strength, with ultimate bond strength achieved after 15 minutes exposure at 160° C. with excellent lap shear strength of greater than 25 MPa with CFRP and greater than 13 MPa with Nylon-CFRP cross bonding. More than 10 MPa lap shear strength has been observed when tested at 100° C.

The rapid curing and the green strength exhibited by embodiments of the adhesive are especially useful for an adhesive being used in an automotive assembly line. Considering the dwell time of components on the assembly lines, the adhesive in the current invention has rapid curing behavior with high short term holding properties. The adhesive may cure rapidly in a few seconds to achieve the required green strength as defined by the automotive manufacturing requirements.

In general, the performance of a structural adhesive at elevated and sub-zero temperatures is very important as far as the mechanical properties of the adhesive are concerned. The adhesive should exhibit extremely good bonding at extreme low temperature and at elevated temperatures that are considered service temperatures of vehicles in various countries. However, most existing epoxy adhesives will crack at sub-zero temperatures, which results in poor mechanical properties, especially adhesive lap shear strength. Lap shear strength of embodiments of the inventive adhesive have been evaluated at −40° C. after exposing bonded assemblies at −40° C. for 24 hours and the recorded strengths were observed without any significant drop when compared with the value recorded at room temperature tests.

A typical formulation of an inventive rapid-cure adhesive is summarized as follows in Table 1:

TABLE 1
Formulations of inventive adhesive with amounts
provided in total weight percentages.

| Inventive Formulation Components | Typical | Preferred |
|---|---|---|
| Curable resin components (total of at least | 60-remainder | 75-remainder |
| two specific resins below): | | |
| Epoxy Novolac Resin | 0-40 | 15.5-32 |
| Solid Epoxy Resin (bisphenol | 0-40 | 15.5-32 |
| A-epichlorohydrin epoxy) | | |
| 4,4′-Isopropylidenediphenol, | 0-40 | 14-20 |
| oligomeric reaction products with | | |
| 1-chloro-2,3-epoxypropane (CAS | | |
| No. 161308-15-2) | | |
| Epoxy curing agent, (dicyandiamide) | 5-17 | 11-16 |
| Cure accelerator | 0-5 | 1-3 |
| Hydrophobic filler | 0-5 | 1-3 |
| Toughening polymer | 0-5 | 1-3 |
| Other conventional additives (each) | 0-5 | 1-3 |

Curable resin components operative in the present invention include a combination of at least two of: a bisphenol A-epichlorohydrin epoxies, epoxy novolac resins, and a reaction product of 4,4-Isopropylidenediphenol, oligomeric reaction products with 1-chloro-2,3-epoxypropane. The bisphenol A epichlorohydrin epoxy has the following structure:

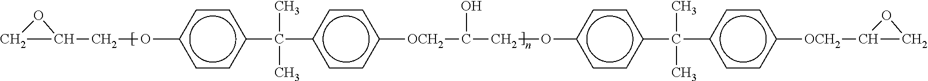

wherein n is an integer from 1 to about 20.

The epoxy novolac resin has the following structure:

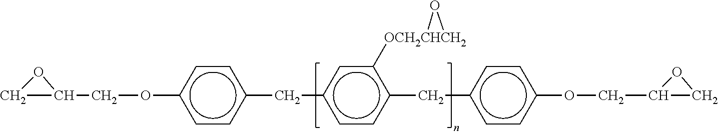

wherein n is an integer from 1 to about 20.

It is appreciated that the values of n are independently chosen for the aforementioned epoxy resin structures. According to the present invention the viscosity is chosen such that the uncured adhesive formulation is solid or semisolid at STP to facilitate handling and operations associated with part manufacture.

The curing agent for the epoxy resin mixture may be any compound having two or more active hydrogen atoms per molecule. Curing agents operative herein include compounds having two or more amino or amido groups per molecule. These illustratively include diamides, polyamines, poly(oxypropylene) amines, and polyamidoamines Suitable polyamines include both aliphatic polyamines and illustratively include ethylene diamine, diethylene triamine, triethylene tetramine, propylene diamine, tetraethylene pentamine, butylene diamine, hexamethylene diamine and aromatic polyamines such as 1,6-diaminobenzene. Resin miscible curing agents may be directly added to resin mixture. Resin immiscible curing agents are dispersed in solvent and then added to the resin mixture or, alternatively, are added to the polymer as 100% curing agent solids and particulate dispersed in the resin mixture.

The adhesive composition of the present invention in some inventive embodiments include other additives known in the art to promote improved properties of handling, manufacture, storage, properties, or a combination thereof. These additives including toughening polymers, hydrophobic fillers, emulsifiers, tackifiers, solvents, pigments, thickeners, humectants, cure accelerators, wetting agents, biocides, adhesion promoters, colorants, waxes, antioxidants, other polymers or combinations thereof. Other polymers operative herein illustratively include polyurethane resins, neoprene rubbers, polyisoprene rubbers, polyvinylidene chloride, styrene butadiene resins, mixtures thereof, and copolymers thereof with epoxies. By way of example, the following polymers impart toughness to and inventive adhesive: Bisphenol F epoxy resin modified with a butadiene-acrylonitrile elastomer imparts toughening to an inventive adhesive, spherical silicone polymer of crosslinked silicone core and a shell based on an organic polymer.

Cure accelerators operative herein are appreciated to often also curing agent functionality. Cure accelerators operative herein illustratively include benzyl dimethyl amine (BDMA), heterocyclic amines, epoxy amine adduct, boron trichloride amine adducts, aliphatic amine adducts, polyamide/urea adduct, urea adducts, 3-(3,4-dichlorophenyl)-1,1-dimetylurea, N-(4-chlorophenyl)-N,N-dimethylurea, phenyldimethylurea, toluenebisdimethylurea, and combinations thereof.

A process of producing an inventive adhesive suitable for bonding at least two substrates includes the following steps.

The formulation components are mixed under condition to preclude premature cure, owing to the high viscosity of inventive formulation even above room temperature this is often accomplished with heating and degassing. An uncured adhesive formulation results.

The uncured adhesive formulation is applied between the substrates at elevated temperature to promote adhesive flow.

The uncured adhesive formulation is then cure between the at least two substrates in a time of less than 1 minute and in some inventive embodiments of less than 40 seconds and in still other embodiments in a time of between 10 and 30 seconds at a cure onset temperatures of at least 140° C. and in some embodiments between 160° C. and 200° C. The uncured adhesive formulation is applied in some embodiments with pre-heating to lower viscosity, yet at a temperature that does not lead to premature curing so as to allow a semisolid bead to be extruded onto one of the at least two substrates. A three-dimensional polymeric adhesive material between the substrates results that bonds the substrates together. The speed and viscosity of the uncured adhesive formulation inhibit bond line read through.

Specific embodiments of an inventive rapid-cure adhesive are formulated as follows:

Tables 2 and 3. Inventive formulations 1 and 2 with amounts provided in total weight percentages.

TABLE 2
Inventive Formulation - 1

| | Weight |
|---|---|
| Components | (total %) |
| Epoxy Novolac Resin, semisolid, Epoxide Group Content | 31.46 |
| (mmol/kg) 5525-5680 | |
| Solid Epoxy Resin product of epichlorohydrin and | 31.46 |
| bisphenol A Epoxide Group Content (mmol/kg) 250-400 | |
| 4,4′-Isopropylidenediphenol, oligomeric reaction products | 15.73 |
| with 1-chloro-2,3-epoxypropane | |
| Methylmethacrylate-butadiene-styrene copolymer | 6.29 |
| dicyandiamide | 12.69 |
| Epoxide curing accelerator (urea adduct - 3 phr) | 2.36 |
| Total | 100.00 |

TABLE 3
Inventive Formulation - 2

| | Weight |
|---|---|
| Components | (total %) |
| Epoxy Novolac Resin, semisolid, Epoxide Group Content | 24.98 |
| (mmol/kg) 5525-5680 | |
| Solid Epoxy Resin product of epichlorohydrin and | 24.98 |
| bisphenol A Epoxide Group Content (mmol/kg) 250-400 | |
| 4,4′-Isopropylidenediphenol, oligomeric reaction | 18.73 |
| products with 1-chloro-2,3-epoxypropane | |
| Bisphenol F epoxy resin modified with a butadiene- | 5.99 |
| acrylonitrile elastomer Epoxide Equivalent Weight, | |
| g/eq 285-330 | |
| Isotridecyl-3-(3,5-di-tert-butyl-4-hydroxyphenyl) | 0.47 |
| propionate | |
| tris(2,4-di-tert-butylphenyl) phosphite | 0.25 |
| Spherical silicone particulate polymer modifier in powder | 9.99 |
| form. | |
| Hydrophobic fumed silica | 1.00 |
| Epoxy functional silane (adhesion promoter) | 0.07 |
| Dicyandiamide | 11.31 |
| Epoxide accelerator (urea adduct - 3 phr) | 2.22 |
| Total | 100.00 |

The present invention is further illustrated with respect to the following non-limiting examples that are intended to illustrate specific aspects of the invention. These examples and comparative examples thereto are not intended to limit the scope of the appended claims.

### EXAMPLE 1

### Cure and Properties of an Inventive Adhesive

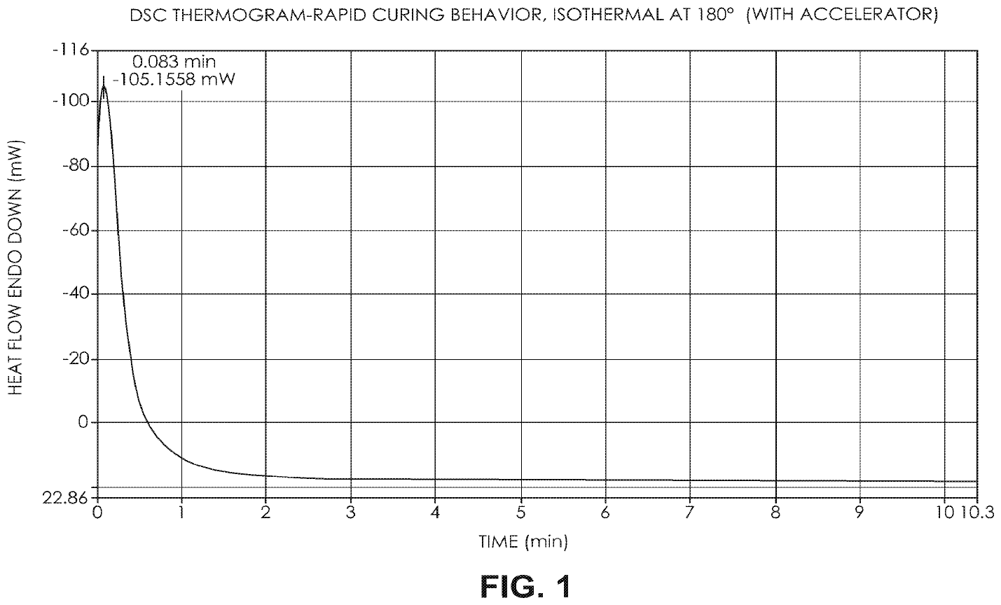

FIG. 1 is an isothermal (180° C.) DSC thermogram graph that depicts the rapid curing behavior of an embodiment of the inventive adhesive formulation 1. The adhesive in FIG. 1 exhibits peak exotherm within 5 seconds. Table 4 illustrates short term holding strengths for various joined substrates when the inventive adhesive is exposed to an elevated curing temperature of 180° C. for 15 seconds. CFRP denotes a carbon fiber reinforced plastic substrates.

TABLE 4
Short term holding strength - 15 Second at 180° C.

| | Exposure | Lap Shear Strength |
|---|---|---|
| Substrates | temperature/Time | (MPa) |
| CFRP-CFRP | 180° C./15 sec | 5.9 MPa |
| Nylon-Nylon | 180° C./15 sec | 3.0 MPa |
| CFRP-Nylon | 180° C./15 sec | 3.5 MPa |

Table 5 provides a summary of test data taken embodiments of the inventive rapid-cure adhesive including density in cured and uncured state, Tg in cured and uncured states, and lap shear strengths for various substrate combinations and temperature/time exposures.

TABLE 5
Adhesive test results for adhesive of inventive formulation 1.
Properties of Adhesive

| Test | Test Standard | Current invention | |
|---|---|---|---|
| Density (Cured) | ASTM D 854 | 0.83 | g/ml |
| Density (Uncured) | ASTM D 854 | 1.15 | g/ml |
| Tg (Cured) | By DSC | 125° | C. |
| Tg (Uncured) | By DSC | 32° | C. |
| Lap shear strength (STHF*), CFRP-CFRP | ASTM D 1002 | 5.9 | MPa |
| Lap shear strength (STHF), CFRP-Nylon | ASTM D 1002 | 3.5 | MPa |
| Lap shear strength (STHF), Nylon-Nylon | ASTM D 1002 | 3.0 | MPa |
| Lap shear strength (Ultimate**), CFRP-CFRP | ASTM D 1002 | >25.0 | MPa |
| Lap shear strength (Ultimate**), CFRP-Nylon | ASTM D 1002 | >15.0 | MPa |
| Lap shear strength (Ultimate**), Nylon-Nylon | ASTM D 1002 | >12 | MPa |
| Lap shear strength (at 100° C.), CFRP-CFRP | ASTM D 1002 | >20.0 | MPa |
| | (Pullrate: 5 mm/min) | | |
| Lap shear strength (at 100° C.), CFRP-Nylon | ASTM D 1002 (Pull | >12.2 | MPa |
| | rate:5 mm/min) | | |
| Lap shear strength (at 100° C.), Nylon-Nylon | ASTM D 1002 (Pull | >11.5 | MPa |
| | rate:5 mm/min) | | |
| Lap shear strength (after exposure at −40° C. for | ASTM D 1002 | >24.5 | MPa |
| 24 hrs), CFRP-CFRP, tested at −40° C. | | | |
| Lap shear strength (after exposure at −40° C. for | ASTM D 1002 | >13.7 | MPa |
| 24 hrs), CFRP-Nylon, , tested at −40° C. | | | |
| Lap shear strength (after exposure at −40° C. for | ASTM D 1002 | >8.5 | MPa |
| 24 hrs), Nylon-Nylon,, tested at −40° C. | | | |

*SHF: - Short term holding force after bonding at 180° C. for 15 sec
**Ultimate: - Cured at 160° C. for 15 min

Table 6 illustrates bond strengths between various bonded substrates following curing of the inventive adhesive for 15 minutes at 160° C. in terms of lap shear strength tested at room temperature and following a 24-hour period where the bonded substrates were held at −40° C. and tested the lap shear strength at −40° C. Virtually no change in lap shear strength between the samples is noted.

TABLE 6
Mechanical properties before and after low temperature exposure

| | | | Lap Shear |
|---|---|---|---|
| | | | Strength (MPa) |
| | | Lap Shear Strength | (Conditioned at |
| | | (MPa) Conditioned | −40° C./24 hr, |
| Substrates | Curing profile | at RT, Tested at RT | tested at −40° C.) |
| CFRP-CFRP | 160° C./15 min | 26.8 MPa | 24.5 MPa |
| Nylon-Nylon | 160° C./15 min | 5.9 MPa | 8.5 MPa |
| CFRP-Nylon | 160° C./15 min | 13.3 MPa | 1.37 MPa |

### EXAMPLE 2

### Curing Study without Accelerator—Isothermal Study at Various Temperature

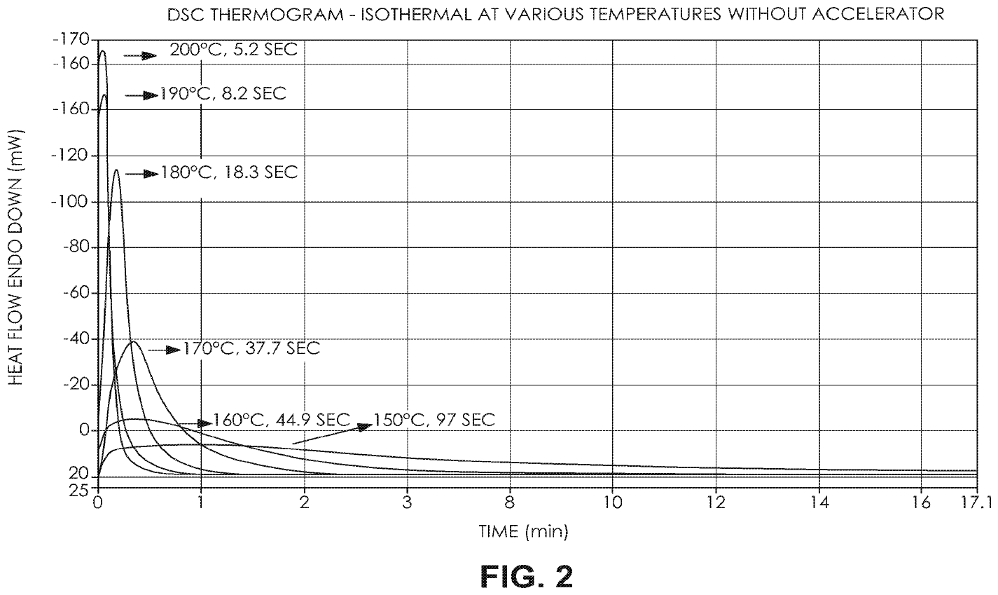

Isothermal curing behavior of adhesive formulation without curing accelerator has been studied at various isothermal temperatures. The isothermal DSC thermogram of formulation in FIG. 2 elucidates the time required to reach peak exotherm at various temperature for the inventive formulation 1 without any accelerator. The peak exotherm indicates the temporal extension curing of the adhesive at the specified temperature. Though the adhesive is curing rapidly above 190° C. as desired, further iterations have been done by incorporating accelerator so as to reduce optimal isotherm cure temperature to 160° C.

### EXAMPLE 3

### Curing Study Accelerator—Isothermal Study at Various Temperature

Curing behavior of adhesive system by incorporating accelerator with the adhesive system of inventive formulation 2 has been studied by DSC from 30° C. to 250° C. at 40° C./min ramp rate. Concentration of polyamide/urea adduct adduct accelerator varies from 0.1 phr to 6 phr; curing onset temperature and curing peak of adhesive system at various concentration are depicted in Table 7. It is evidenced that the onset of curing and the curing peak is shifted to lower temperature with the increment of accelerator concentration. Considering various processing aspects, as the mixing process is being carried out at 160° C., 3 phr of accelerator concertation has been selected for further exploration of this adhesive formulation.

TABLE 7
Reaction onset temperature and curing peak temperature as a function
of cure accelerator concentration in inventive formulation 2.

| Accelerator conc. | DSC Peak onset | DSC curing peak |
|---|---|---|
| (phr) | (° C.) | (° C.) |
| 0 | 169.43 | 195.39 |
| 0.1 | 167.03 | 192.67 |
| 0.15 | 167.28 | 193.31 |
| 0.25 | 165.25 | 192.26 |
| 0.5 | 161.65 | 190.17 |
| 1 | 159.65 | 188.19 |
| 2 | 158.3 | 190.77 |
| 3 | 149.04 | 180.98 |
| 5 | 138.69 | 172.51 |

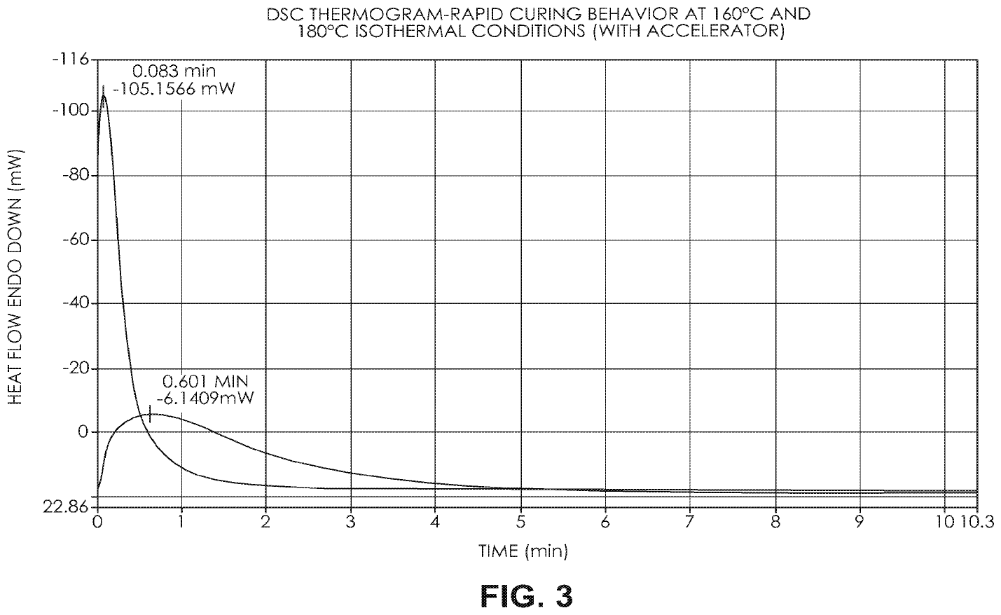

Rapid curing of adhesive formulation with 3 phr accelerator has been studied at 180° C. and 160° C. isothermal condition in order to understand rapid curing behavior of adhesive system. The thermogram of FIG. 3 indicates that the peak exotherm happening around 5 seconds and 36 seconds at 180° C. and at 160° C., respectively.

The foregoing description is illustrative of particular embodiments of the invention, but is not meant to be a limitation upon the practice thereof. The following claims, including all equivalents thereof, are intended to define the scope of the invention.

1. A process for adhesively bonding at least two substrates comprising:
applying to the at least two substrates, an uncured adhesive formulation comprising: at least two curable resin components of:
epoxy novolac resin having the following structure: 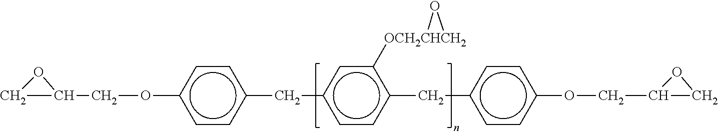
wherein n is an integer from 1 to about 20,
bisphenol A-epichlorohydrin epoxy having the following structure: 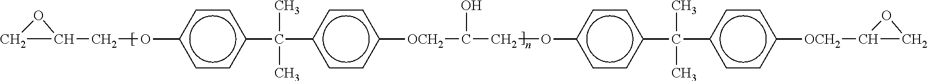
wherein n is an integer from 1 to about 20,
or 4,4′-Isopropylidenediphenol, oligomeric reaction products with 1-chloro-2,3-epoxypropane in a total amount of at least 60 total weight percent, an epoxy curing agent, and epoxy curing accelerator; and
allowing said uncured adhesive formulation to cure at an elevated onset temperature of at least 140° C. to adhesively bonding the at least two substrates in a time of less than 1 minute.

2. The process of claim 1 further comprising heating said uncured adhesive formulation prior to said applying.

3. The process of claim 1 wherein the at least two substrates are vehicle components.

4. The process of claim 1 wherein the elevated onset temperature is between 160° C. and 200° C.

5. The process of claim 1 wherein said uncured adhesive formulation is applied as a bead.

6. The process of claim 1 wherein one of the at least two substrates is one of a carbon reinforced plastic (CFRP) or filled nylon.

7. The process of claim 6 wherein all of the at least two substrates are either of said CFRP or said filled nylon.

8. An uncured adhesive formulation to cure at an elevated onset temperature of at least 140° C. to adhesively bonding the at least two substrates in a time of less than 1 minute comprising:
at least two curable resin components of:
epoxy novolac resin having the following structure: 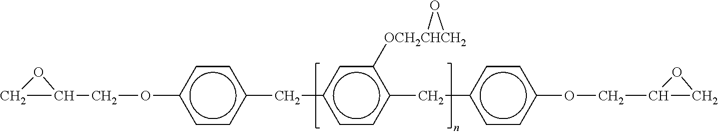
wherein n is an integer from 1 to about 20,
bisphenol A-epichlorohydrin epoxy having the following structure: 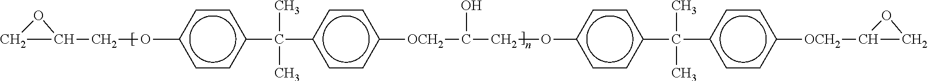
wherein n is an integer from 1 to about 20,
or 4,4′-Isopropylidenediphenol, oligomeric reaction products with 1-chloro-2,3-epoxypropane in a total amount of at least 60 total weight percent;
an epoxy curing agent; and
an epoxy cure accelerator.

9. The formulation of claim 8 wherein said at least two curable resin components are all three of epoxy novolac resin, bisphenol A-epichlorohydrin epoxy, or 4,4′-Isopropylidenediphenol, oligomeric reaction products with 1-chloro-2,3-epoxypropane in an amount of at least 75 total weight percent.

10. The formulation of claim 8 wherein said epoxy curing agent is one or more of a diamide, a polyamine, a poly(oxypropylene) amine, dicyandiamide or a polyamidoamine.

11. (canceled)

12. The formulation of claim 8 wherein said epoxy cure accelerator is one or more of benzyl dimethyl amine (BDMA), heterocyclic amines, epoxy amine adduct, boron trichloride amine adducts, aliphatic amine adducts, urea adducts, 3-(3,4-dichlorophenyl)-1,1-dimetylurea, N-(4-chlorophenyl)-N,N-dimethylurea, phenyldimethylurea, or toluenebisdimethylurea.

13. The formulation of claim 8 having a viscosity of a solid or a semisolid at standard temperature and pressure (STP).

14. The formulation of any claim 8 further comprising at least one of bisphenol F epoxy resin modified with a butadiene-acrylonitrile elastomer or spherical silicone polymer of crosslinked silicone core and an organic polymer shell.

15. The formulation of any claim 8 further comprising an epoxy-silane.

16. An assembly comprising:
a first substrate of filled nylon or carbon fiber filled polymer;
a second substrate of filled nylon or carbon fiber filled polymer; and
a layer of cure adhesive of claim 8 in simultaneous contact with the first substrate and the second substrate.
